(19) United States
(12) Patent Application Publication
(10) Pub. No.: US 2026/0274727 A1
(43) Pub. Date: Sep. 17, 2026

(54) WATER EVAPORATION AND MINERAL EXTRACTION DEVICES

(71) Applicant: The Trustees of Princeton University, Princeton, NJ (US)

(72) Inventors: Sunxiang ZHENG, Franklin Park, NJ (US); Zhiyong Jason REN, Princeton, NJ (US)

(73) Assignee: The Trustees of Princeton University, Princeton, NJ (US)

(21) Appl. No.: 19/168,123

(22) PCT Filed: Mar. 19, 2024
(86) PCT No.: PCT/US2024/020557

§ 371 Date: Sep. 23, 2025

Related U.S. Application Data
(60) Provisional application No. 63/454,230, filed on Mar. 23, 2023.
(60) Provisional application No. 63/531,130, filed on Aug. 7, 2023.

(51) Int. Cl. C02F 9/00; C02F 1/14; C02F 1/28; C02F 1/52; C02F 101/10; C22B 3/02; C22B 3/24; C22B 26/12

(52) U.S. Cl. CPC C02F 9/00; C22B 3/02; C22B 3/24; C22B 26/12; C02F 1/14; C02F 1/281; C02F 1/52; C02F 2101/10

(57) ABSTRACT

A device, system, and method for enhancing solar evaporation may be provided. Devices may include a solar absorption material. A buoyancy of the device may be configured or configurable such that the solar absorption material will be disposed an average distance d below a surface of a liquid when the device is placed in the liquid, where 0<d≤10 cm. The solar absorption material may include a plurality of layers, including a carbonaceous light absorbing layer and at least one additional layer. The at least one additional layer may include a reflective layer disposed below the carbonaceous light absorbing layer, an anti-reflection layer disposed above the carbonaceous light absorbing layer, and/or a first layer disposed above the carbonaceous light absorbing layer and any anti-reflection layer, where the first layer may consist of an anti-scaling layer, a photocatalyst layer, or a selective mineral adsorption layer.

### CROSS-REFERENCE TO RELATED APPLICATIONS

The present disclosure claims priority to US Provisional Patent Application No. 63/453,230, filed Mar. 23, 2023, and 63/531,130, filed Aug. 7, 2023, the contents of which are both incorporated by reference in its entirety.

### STATEMENT REGARDING FEDERALLY SPONSORED RESEARCH OR DEVELOPMENT

This invention was made with government support under Grant No. DMR2011750 awarded by the National Science Foundation. The government has certain rights in the invention.

### TECHNICAL FIELD

The present disclosure relates to techniques used in evaporative processes, such as mineral extraction via water evaporation.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

There are many useful applications that include evaporative processes, and particularly water evaporation, such as wastewater treatment, water desalination, and extraction of dissolved minerals. The acceleration of such applications often rely solely on natural evaporation. Large quantities of water may be stored in natural or constructed ponds for an extended period of time to allow natural evaporation. However, water as a transparent liquid has a poor solar absorption capability and therefore can only convert less than 50% of the solar irradiation in a day into thermal energy for evaporation. Moreover, due to the high thermal conductance and heat convection occurring in the water, most of the thermal energy will quickly dissipate, resulting in a slow evaporation rate.

As an example, the current method for extracting lithium from brine, specifically at the “Lithium Triangle” of Bolivia, Chile, and Argentina, involves pumping brine from underground wells and evaporating it in large pools to concentrate the lithium. This process can take up to 18 months and requires a significant amount of land resources.

Existing evaporator design faces challenges in fouling and scaling especially in high salinity water or the presence of other contaminants. This is in part due to the material exposure of water-air interface, and in some cases, floating salt crystals, also known as “salt rafts”, can be observed on the surface of lithium brines when evaporation is particularly strong. Such salt rafts can severely curtail evaporation rates.

### BRIEF SUMMARY

Various deficiencies in the prior art are addressed below by the disclosed compositions of matter and techniques.

In various aspects, a device for enhancing solar evaporation may be provided. The device may include a solar absorption material. A buoyancy of the device may be configured or configurable such that the solar absorption material will be disposed an average distance d below a surface of a liquid when the device is placed in the liquid, where 0<d≤10 cm, such as 0.1 mm≤d≤10 mm, and/or 2 mm≤d≤5 mm. The average distance d may be configured to be adjusted by, e.g., adding or removing a floatation module, adding or removing a weight, or selecting a material of construction with a different density. The device may be configured to be placed in a fluid, such that a layer of the fluid disposed above the device will be evaporated at a rate greater than a rate due to bulk evaporation.

The solar absorption material may comprise or consist of a carbonaceous light absorbing layer. The carbonaceous light absorbing layer may include carbon black particles. The carbon black particles may be disposed in the carbonaceous light absorbing layer in a size gradient. The carbonaceous light absorbing layer may include silicone dioxide nanoparticles disposed over the carbon black particles.

The solar absorption material may consist of a plurality of layers. The plurality of layers may include the carbonaceous light absorbing layer and at least one additional layer. The at least one additional layer may consist of: (i) a reflective layer disposed below the carbonaceous light absorbing layer; (ii) an anti-reflection layer disposed above the carbonaceous light absorbing layer; and/or (iii) a first layer disposed above the carbonaceous light absorbing layer and any anti-reflection layer. The first layer may consist of an anti-scaling layer, a photocatalyst layer, or a selective mineral adsorption layer.

The reflective layer may include aluminum and an acrylic polymer, a polyurethane, or an epoxy. The photocatalyst layer may include a photocatalyst in a binder resin. The binder resin may be an acrylic polymer. The photocatalyst may be TiO₂, C₃N₄, ZnO, ZnS, CdS, SrO₂, WO₃, or a combination thereof. The selective mineral adsorption layer may be a lithium-selective adsorption layer. The lithium-selective adsorption layer may include a Li/Al layered double hydroxide (LDH). The anti-scaling layer may include an organosilane and/or at least one layer of polyacrylic acid (PAA) coupled to at least one layer of polyethylenimine. The solar absorption material contains at least one hydrophobic surface. The solar absorption material may include a superhydrophobic spray coating on at least one surface of the solar absorption material (such as the substantially flat surface). The solar absorption material may be porous. The solar absorption material may be non-porous. The solar absorption material may have at least one outer surface colored black. The solar absorption material may have a curved surface facing upwards. The solar absorption material may have a substantially planar surface facing upwards.

The solar absorption material may define at least one hollow, three-dimensional shape, where the at least one hollow, three-dimensional shape is configured to extend down into a liquid from the solar absorption material when the device is placed in a liquid. The at least one hollow, three-dimensional shape may include a plurality of hollow, three-dimensional shapes. Each hollow, three-dimensional shape may be identical. At least one hollow, three-dimensional shape may be different from at least one other hollow, three-dimensional shape.

The device may include one or more floatation modules operably coupled to the substantially flat surface. The one or more floatation modules may include a plurality of flotation modules. The one or more floatation modules may be configured to control buoyancy of the device. The one or more floatation modules may be removably coupled to the device. A majority of a volume of each floatation module may be above a surface of a fluid when the device is placed in the fluid. Each floatation module may have a non-black coloring. Each floatation module may have a reflective coating.

Each floatation module may have a cross-sectional area on a plane parallel to a plane defining the substantially flat surface, where the cross-sectional area (e.g., the maximum cross-sectional area) of each floatation module is less than 5% of the cross-sectional area of the substantially flat surface. A cross-sectional area of each floatation module at a first point closest to the substantially flat surface may be smaller than a cross-sectional area of each floatation module at a second point (or at any point) further from the substantially flat surface. Each floatation module may be operably coupled to the device via an adjustable screw or bolt, the adjustable screw or bolt configured to adjust a distance of its floatation module relative to the substantially flat surface.

The device may include one or more protrusions extending upwards from the substantially flat surface. The one or more protrusions may be configured to cause the device to rotate when disposed in a liquid. At least a first protrusion of the one or more protrusions may extend a first distance above the substantially flat surface, and at least a second protrusion may extend a second distance above the substantially flat surface different from the first distance, where the first distance may be a minimum desired liquid film thickness and the second distance may be a maximum desired liquid film thickness.

The device may include one or more weight modules operably coupled to the substantially flat surface and the one or more floatation modules to balance a position of the device in the liquid.

The device may include a base substrate coupled to the solar absorption material. The device may include one or more protrusions extending downwards from the base substrate. The protrusion(s) may be configured to be disposed within a liquid when the device is placed in a liquid. The protrusion(s) may be configured to cause the device to rotate when disposed in the liquid.

A cross-section of the device, when viewed from above, may be a geometric shape. A cross-section of the device, when viewed from above, may not include any flat edges. A bottom surface of the device, when viewed from the side, may have a non-linear cross-section.

In various aspects, a floating evaporator may be provided. The floating evaporator may include a porous frame with sidewalls and a bottom surface defining an internal volume of space. The porous frame may allow a fluid to enter the internal volume of space. The floating evaporator may include an embodiment of a device as disclosed herein coupled to the porous frame and disposed in the internal volume of space. The porous frame may be comprised of a polymeric material. The polymeric material may be polylactic acid (PLA), acrylonitrile butadiene styrene (ABS), acrylonitrile styrene acrylate (ASA), High-Density Polyethylene (HDPE), polyethylene terephthalate (PET), polypropylene (PP), polyether ether ketone (PEEK), or a combination thereof. The floating evaporator may have at least one surface feature configured to cause the floating evaporator to rotate around an axis based on evaporation rate of the fluid. The floating evaporator may include a weight or buoyant material operably coupled to a bottom surface of the porous frame.

In various aspects, a method for enhancing solar evaporation may be provided. The method may include providing an embodiment of a device as disclosed herein, and allowing a liquid to contact the device (and specifically, the solar absorption material). The method may include allowing at least some of the liquid to be evaporated when the device (and specifically, the solar absorption material) is at least partially exposed to solar energy. The method may include, after allowing at least some of the liquid to be evaporated, removing at least one target material (such as lithium) from an external surface of the device. The method may include positioning the device at least partially below a surface of a liquid. The device may be configured to trap solar energy in a volume of space from the surface to an average distance d below the surface, where 0<d≤10 cm.

In various aspects, a method for collecting a target material from a fluid may be provided. The method may include providing an embodiment of a device as disclosed herein, the device including a selective mineral adsorption layer that is selective to the target material. The method may include allowing the fluid to contact the device. The method may include evaporating at least one material from the fluid and collecting either the at least one material or a material remaining on a surface of the device. The fluid may comprise water and at least two alkali metals.

The fluid may comprise water and at least one alkali metal nitrate. The alkali metal nitrate may be, e.g., sodium nitrate and/or potassium nitrate. The evaporation may be configured to remove impurities in the water other than the sodium nitrate and/or potassium nitrate. The device may be used as a way to actively adjust the evaporation rate of the fluid (which may be, e.g., a solar evaporation pond), for the fine controlling of a nitrate saturate point in the fluid. The device may be used to accelerated evaporation, to reduce the volume of the waste stream and precipitate additional nitrate salts. In some embodiments, a combination of all of these may be utilized.

In various aspects, a system for evaporating a liquid may be provided. The system may include a liquid. The system may include one or more devices, each device an embodiment of a device as disclosed herein. Each device may be disposed within the liquid (which may comprise water), where the substantially flat surface of each device is disposed an average distance d below a surface of a liquid when the device is placed in the liquid, where 0<d≤10 cm, such as 0.1 mm≤d≤10 mm, or such as 2 mm≤d≤5 mm. The liquid may be wastewater. The liquid may be ground water. The liquid may be produced water. The liquid may be from a salar (a salt-encrusted depression that may or may not be the basin of an evaporated lake) or salt flat. The liquid may be seawater. The liquid may include a target mineral (such as lithium) to be removed.

### BRIEF DESCRIPTION OF THE FIGURES

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1A is an illustration of a device.

FIG. 1B is a schematic showing a cross-section of a substrate.

FIG. 2 is an illustration of a device.

FIGS. 3A-3F are illustrations of various floatation modules, including spherical (3A), cylindrical (3B), conical (3C), hexagonal prism (3D), toroidal (3E), and ellipsoidal (3F).

FIG. 4A is an illustration of a device.

FIG. 4B is a top-down view of an embodiment of a device.

FIG. 5 is an illustration of a device.

FIGS. 6A and 6B are illustrations of devices with multiple identical (6A) or non-identical (6B) hollow, three-dimensional shape extending downward.

FIG. 7 is an illustration of a floating evaporator.

FIG. 8 is an illustration of a system.

FIG. 9 is a flowchart of a method for enhancing solar evaporation.

FIG. 10 is a flowchart of a method for collecting a target material from a fluid.

FIG. 11 is an illustration of a simplified example of evaporating and collecting a fluid.

FIGS. 12A-12C are side views of cutaways of a first surface, including convex (12A), concave (12B), and mixtures of convex and concave surfaces (12C).

FIGS. 13A and 13B are illustrations of a device, including a view of the top (13A) and bottom (13B) of the device.

FIG. 13C is a side view cutaway of FIG. 13A when disposed in a fluid.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

The disclosed devices are preferably designed to float within a fixed distance of a surface of a fluid. The device is configured to manipulate the crystallization process by changing the water temperature on the top of the device and below the device. Specifically, the device enables localized temperature changes (e.g., warmer above the device and cooler below), and such change enables different crystallization processes. For example, temperature changes and/or concentration changes can be used to cause dissolved substances to become supersaturated and crystallize, and the crystals may then separate (or be separated) from the liquid.

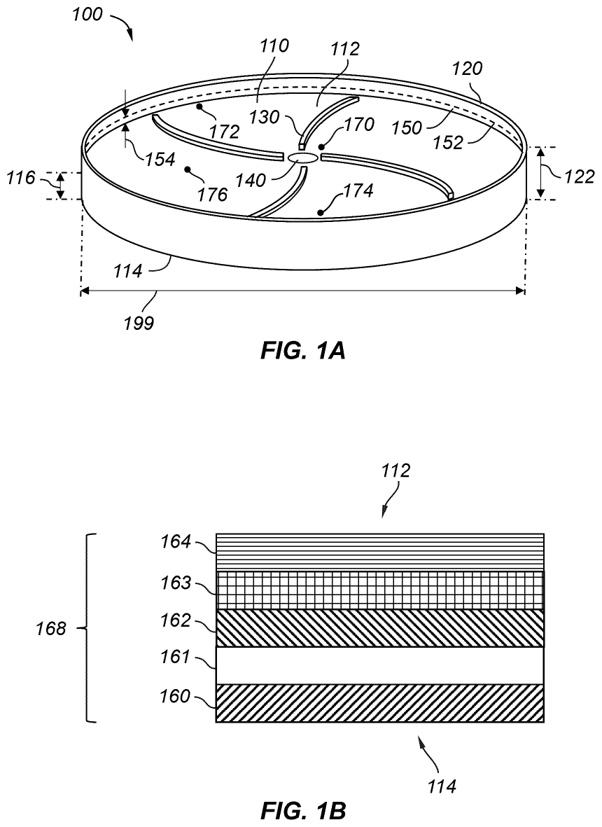

Referring to FIG. 1A, an embodiment of a device for enhancing solar evaporation can be seen. The device (100) may include a central portion (110) having first surface (112) and a second surface (114) opposite the first surface. The first surface and second surfaces may be separated by a thickness (116) or height.

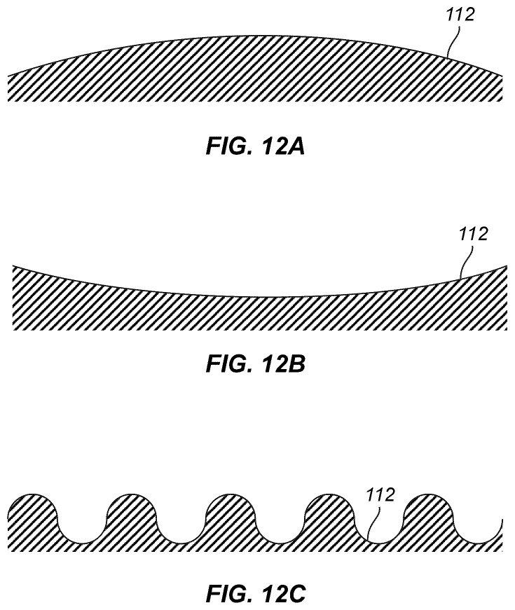

The first surface may be substantially flat surface. The substantially flat surface may be substantially planar surface. As used herein, the term “substantially flat” surface refers to a relatively smooth surface. Relatively smooth surfaces may have an average surface roughness of less than 10 μm, preferably less than 1 μm, and more preferably less than 0.1 μm. As used herein, the term “substantially planar” may include where every point on the surface (e.g., first point (170)) is within 0.5 mm of a plane containing any three other points on the same surface (e.g., second point (172), third point (174), and fourth point (176)). The substantially flat surface may face upwards (e.g., towards the sky when the device is placed in a pool of liquid). The first surface may be a non-planar surface. For example, the substantially flat surface may be a curved surface. Referring to FIGS. 12A-12C, in some embodiments, the curved surface may be a convex surface (12A), a concave surface (12B), or a mixture of concave and convex surfaces (12C).

The device may include sidewalls (120). The sidewalls may have a thickness (122) or height greater than a thickness (116) or height of the central portion (110).

The device may include one or more features (130) on the first surface and/or the second surface that extend outwards from the surface (e.g., protrusions extending upwards away from a substantially flat surface). The features may be curved, so as to form an arc on the surface. The features may be configured so as to cause the device to rotate when disposed in a liquid (e.g., motion of the fluid past the features causes the device to rotate around a central axis of the device).

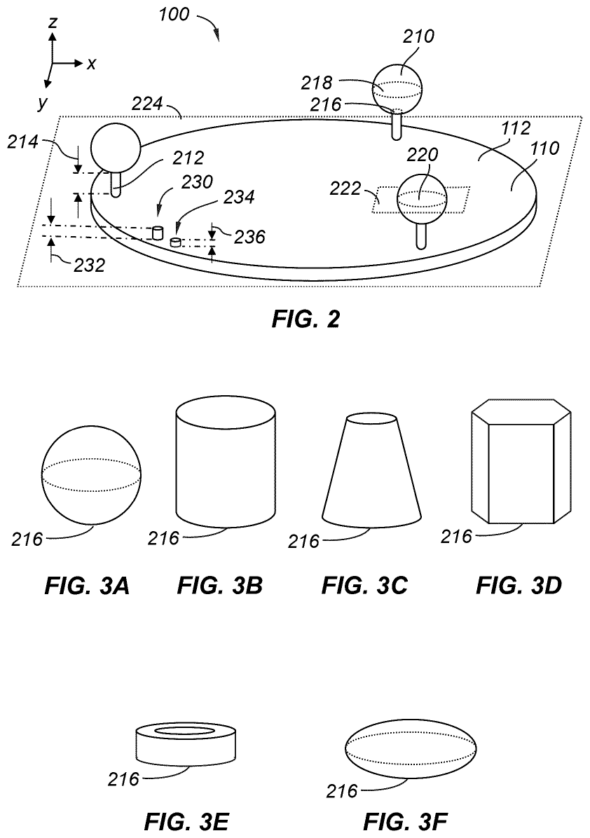

Referring briefly to FIG. 2, the features may include a first protrusion (230) that extends a first distance (232) above (e.g., in the +z direction, which may be preferably perpendicular to a surface of a fluid the device is intended to be floating in) the first surface (112), which may be a substantially flat surface. The features may include a second protrusion (234) that extends a second distance (236) above the substantially flat surface. The first distance may be different from the second distance. The first distance may be a minimum desired liquid film thickness and the second distance may be a maximum desired liquid film thickness. The first and second protrusions may be colored differently or have different geometric shapes to allow easier visual recognition of where a fluid surface is relative to the two protrusions.

Referring again to FIG. 1A, The device may include a hole (140) or opening, which may extend from the first surface (112) to the second surface (114). This may allow a fluid (e.g., an aqueous fluid, such as water which may contain one or more other components such as a dissolved mineral, etc.) to flow from under the device to form a film (150) on the first surface (112). The film may have an air-fluid interface (152) a distance (154) from the first surface (112).

The buoyancy of the device may be configured or controlled (e.g., by adding weights to the device or removing weights from the device) to achieve a desired degree of buoyancy when floating on a fluid (e.g., on a lake, in a vessel, etc.). In some aspects, buoyancy of the device may be configured or configurable such that the solar absorption material (and in particular an upward-facing surface of the solar absorption material, which may be the first surface) may be disposed an average distance d (in FIG. 1A, this is shown as distance (154)) below a surface of a liquid when the device is placed in the liquid. This distance is preferably controllable or adjustable, so as to allow for control of the rate of evaporation of the fluid above the device. Such position allows a thin film evaporation, meaning that the device allows the faster evaporation of the thin layer of, e.g., saline water above the device surface (e.g., above first surface (112)), which is different from the bulk evaporation that allows solar irradiation to penetrate the whole water body. That is, the device is configured to evaporate a layer of fluid based on the concentrated heating and evaporation generated by the device, as opposed to the heating and evaporation of the bulk water body by the sun. Such concentrated evaporation on the thin film water layers allows faster evaporation layer by layer.

In some embodiments, the device may be configured such that 0<d≤10 cm. In some embodiments, the device may be configured such that 0.1 mm≤d≤10 mm. In some embodiments, the device may be configured such that 2 mm≤d≤5 mm. In some embodiments, d is no more than 10 cm. In some embodiments, d is no more than 9 cm. In some embodiments, d is no more than 8 cm. In some embodiments, d is no more than 7 cm. In some embodiments, dis no more than 6 cm. In some embodiments, d is no more than 5 cm. In some embodiments, d is no more than 4 cm. In some embodiments, d is no more than 3 cm. In some embodiments, d is no more than 2 cm. In some embodiments, d is no more than 10 mm. In some embodiments, d is no more than 9 mm. In some embodiments, d is no more than 8 mm. In some embodiments, d is no more than 7 mm. In some embodiments, d is no more than 6 mm. In some embodiments, d is no more than 5 mm. In some embodiments, d is greater than 0 mm. In some embodiments, d is at least 0.1 mm. In some embodiments, d is at least 1 mm. In some embodiments, d is at least 2 mm. In some embodiments, d is at least 3 mm. In some embodiments, d is at least 4 mm. In some embodiments, d is at least 5 mm. In some embodiments, d is at least 1 cm.

To aid in the solar evaporation process, the device may include at least one outer surface (such as first surface (112)) that is colored black.

The device in FIG. 1A is shown as having a circular cross-section, when viewed from above. However, the cross-section, when viewed from above, may be any appropriate shape. In some aspects, when viewed from above, the cross-section of the device may be a geometric shape. In some embodiments, when viewed from above, the cross-section of the device may comprise or consist of a curved shape. In some embodiments, when viewed from above, a cross-section of the device may not include any flat edges. In some embodiments, when viewed from above, the cross-section of the device may comprise or consist of two or more straight segments (e.g., to form a triangular, rectangular, pentagonal, or hexagonal cross-section).

A bottom surface of the device (e.g., second surface (114), or a surface intended to be in contact with a liquid) may have a linear cross-section when viewed from a side (e.g., may be flat). In some embodiments, a bottom surface of the device may have has a non-linear cross-section when viewed from a side. For example, a bottom surface may be conical or hemispherical.

The disclosed devices may have any cross-sectional shape when viewed from above. In FIG. 1A, the device is shown as having a circular cross-section when viewed from above, but the device could be, e.g. hexagonal, square, etc., as desired. A characteristic dimension (e.g., diameter (199), length, width, major axis, etc., depending on the cross-sectional design) may be any size. In some embodiments, the characteristic dimension may be 0.01 m-100 m. In some embodiments, the characteristic dimension may be 0.1 m-2 m.

The device may include one or more synthetic materials. The device may include one or more naturally occurring materials. The device may include one or more polymers. The device may include one or more metals. The device may include ceramic, wood and/or biomass.

The device may include a solar absorption material. The solar absorption material may be porous. The solar absorption material may be non-porous.

The solar absorption material may include one or more layers. In some embodiments, the one or more layers may include a carbonaceous light absorbing layer (162). The term “carbonaceous” refers to a core or layer comprising carbon. The carbonaceous light absorbing layer may include a black oxide treatment, a carbon black coating, a stain, or other suitable light absorbing material containing carbon. In some embodiments, the carbonaceous light absorbing layer may comprise or consist of carbon black particles. In some embodiments, the carbon black particles may be disposed in the carbonaceous light absorbing layer in a size gradient. In some embodiments, the carbonaceous light absorbing layer may comprise or consist of silicone dioxide nanoparticles disposed over carbon black particles. The carbonaceous light absorbing layer may include an anti-scaling component as well.

The solar absorption material may include a plurality of layers. In particular, the central portion (110) of the device may have a plurality of layers that defines the structure between the first surface (112) and the second surface (114). Referring to FIG. 1B, the plurality of layers may include the carbonaceous light absorbing layer (162) and at least one additional layer.

The plurality of layers (168) may include a first layer (164) disposed above the carbonaceous light absorbing layer. The first layer may consist of an anti-scaling layer, a photocatalyst layer, or a selective mineral adsorption layer.

For many applications, if the anti-scaling properties (which includes anti-fouling) are not incorporated into the light absorbing layer, a separate anti-scaling layer may be provided. The anti-scaling layer may include one or more antiscalants. Antiscalants are well-understood in the art, and describe a family of chemicals designed to inhibit the formation and precipitation of crystallized mineral salts that form scale. Antiscalants include, e.g., synthetic polymers, such as polyacrylic acids, carboxylic acids, polymaleic acids, organophosphates, polyphosphates, phosphonates, anionic polymers, etc. The molecular weight of these polymers can vary, although some antiscalants may have molecular weights ranging from 2,000 to 10,000 Da. In one embodiment, the anti-scaling layer may include an organosilane. In one embodiment, the anti-scaling layer may include at least one layer of polyacrylic acid (PAA) coupled to at least one layer of polyethylenimine. In one embodiment, the anti-scaling layer may include an organosilane and at least one layer of polyacrylic acid (PAA) coupled to at least one layer of polyethylenimine.

For certain applications, such as treating wastewater or mine tailings, the minerals in the water or other fluid may benefit from being exposed to a photocatalytic layer instead of an anti-scaling layer. For example, if a mineral of interest is Cu, Ni, Co, Ag, Se, Pb, As, Fe, Au, Sn, or Cr, use of a photocatalyst may be appropriate. The photocatalyst layer may include one or more photocatalysts. As used herein, the term “photocatalyst” refers to a semiconductor material (such as a powder) capable of generating a chemical reaction upon absorption of photons of suitable energy matching the bandgap thereof, e.g., energy that is at least as high as the bandgap energy of the photocatalyst. The photocatalysts may include a quantum dot photocatalyst, non-limiting examples of photocatalysts include, e.g., Zns, CdS, SrO₂, TiO₂, C₃N₄, ZnO, WO₃, or a combination thereof. The photocatalyst may be selected based on the intended application of the device.

In some embodiments, the photocatalyst layer may include a photocatalyst in a binder resin. Any appropriate binder resin may be used; a non-limiting example is an acrylic polymer.

For other minerals in these kinds of alternative applications, being exposed to a selective mineral adsorption layer may be appropriate. For example, if a mineral of interest is Zn, Al, Ca, Mg, Na, K, or Li), use of a photocatalyst may be appropriate. The selective mineral adsorption layer may be a solid adsorbent, such as a zeolite or a hydroxide. In some embodiments, the selective mineral adsorption layer may be a lithium-selective adsorption layer. In some embodiments, the lithium-selective adsorption layer may include a Li/Al layered double hydroxide (LDH), such as a LiCl·Al₂(OH)₆ layered double hydroxide. Other LDHs, and specifically layered double hydroxide chlorides, will be recognized by those skilled in the art.

The plurality of layers may include an anti-reflection layer (163) disposed below any first layer (164) and above the light absorbing layer. Such anti-reflection layers are well-known in the art. Such layers may comprise, e.g., silicon nitride, silicon oxide, titanium oxide, or aluminum oxide. A non-limiting example of an anti-reflection layer is one comprising SiO₂ nanoparticles, such as nanorods, nanospheres, etc. (nanoparticles being particles having a characteristic length or diameter less than 100 nm). In some embodiments, the anti-reflection layer may only be present when an anti-fouling layer is present. Said differently, in some embodiments where a photocatalytic layer or selective mineral adsorption layer is present, the plurality of layers may be free of an anti-reflection layer.

The plurality of layers may include a reflective layer (161) disposed below the carbonaceous light absorbing layer (162). The reflective layer may include one or more metals or alloys thereof. The reflective layer may include a single metal or metal alloy. The metals or metal alloys may include copper, aluminum, nickel, or chromium, or an alloy thereof. The reflective layer may include a metal (e.g., aluminum) or metal alloy and a resin. The resin may be any appropriate resin. In some embodiments, the resin may be an acrylic polymer. In some embodiments, the reflection layer may only be present when an anti-fouling layer is present. Said differently, in some embodiments where a photocatalytic layer or selective mineral adsorption layer is present, the plurality of layers may be free of a reflection layer.

The plurality of layers may include a substrate layer (160) disposed below the reflective layer (161). The substrate layer may include any appropriate layer or layers configured to be coupled to the reflective layer. In some embodiments, the substrate may include a polymer. In some embodiments, the substrate may include a metal or metal alloy. In some embodiments, the substrate may include a foam or aerogel.

A surface of the solar absorbing material may be hydrophobic. A surface of the solar absorbing material may be hydrophilic.

### Example 1

### Forming Layered Structure

A reflective layer was synthesized by mixing 1 g of aluminum powder (<150 pm) with 45 ml of ethyl acetate, 50 ml of isopropyl alcohol, and 5 ml of acrylic liquid. The mixture was then coated onto a substrate surface using an air sprayer and allowed to settle at room temperature. The carbonaceous light absorbing layer was created by suspending 500 mg of carbon black particles with a size gradient in a mixture of 50 ml of DI/isopropyl alcohol (3:1 vol. %). To achieve the size gradient, centrifugal force was applied in stages, starting with 10 G for 15 minutes to precipitate the larger particles. The precipitate was then collected, resuspended in the DI/isopropyl alcohol mixture, and coated using the spray method. This process was repeated with increasing levels of centrifugal force, including: 100 G for 10 minutes, 1000 G for 10 minutes, and 10,000 G for 10 minutes, with the final precipitate being collected and resuspended in the Dl/isopropyl alcohol mixture. 10 wt. % of SiO₂ nanoparticles was then added to the mixture and spray-coated as the anti-reflection layer. The anti-scaling was constructed using layer-by-layer assembly method. The evaporator was soaked in 100 mM polyacrylic acid (PAA) and 100 mM polyethylenimine solution alternatively.

Referring to FIG. 2, embodiments of the device may include a floatation module (210) operably coupled to the first surface (112). The first surface may be a substantially flat surface or a curved surface. The floatation module(s) may be configured to control the buoyancy of the device. The device may include a single floatation module. The device may include a plurality of floatation modules. The device may include three or more floatation modules.

Each floatation module may have a non-black coating (e.g., a white coating). Each floatation module may have a reflective coating.

Each floatation module may have a cross-sectional area (220) on a plane (222) parallel to a plane (224) defining the substantially flat surface (112), where the cross-sectional area of each floatation module may be less than 5% of the cross-sectional area of the substantially flat surface. In some embodiments, the cross-sectional area of each floatation module may be no more than 5% of the cross-sectional area of the substantially flat surface. In some embodiments, the cross-sectional area of each floatation module may be no more than 4% of the cross-sectional area of the substantially flat surface. In some embodiments, the cross-sectional area of each floatation module may be no more than 3% of the cross-sectional area of the substantially flat surface. In some embodiments, the cross-sectional area of each floatation module may be at least 0.1% of the cross-sectional area of the substantially flat surface. In some embodiments, the cross-sectional area of each floatation module may be at least 1% of the cross-sectional area of the substantially flat surface. In some embodiments, the cross-sectional area of each floatation module may be at least 2% of the cross-sectional area of the substantially flat surface.

Each floatation module may be directly or indirectly coupled to surface of the device. Preferably, the floatation modules may be coupled to the first surface (112), which may be a substantially flat surface. In some embodiments, each floatation module may be operably coupled to the device via an adjustable screw or bolt or anchor (212), the adjustable screw or bolt or anchor configured to adjust a distance (214) of its floatation module (210) relative to the first surface (which may be a substantially flat surface).

Each floatation module may be solid. Each floatation module may be hollow. Each floatation module may have a density less than a density of saline water. Each floatation module may have a density less than 500kg/m³. Each floatation module may have a density less than 400 kg/m³. Each floatation module may have a density less than 300kg/m³. Each floatation module may have a density less than 200kg/m³. Each floatation module may have a density less than 100 kg/m³.

In some embodiments, a cross-sectional area of each floatation module at a first point (216) closest to the substantially flat surface (112) may be smaller than a cross-sectional area of each floatation module at a second point (218) that is located further from the substantially flat surface.

Referring briefly to FIGS. 3A-3D, there is no substantive restriction on the shape of each floatation module. In some embodiments, each floatation module is identical. In some embodiments, at least one floatation module has a different shape than another floatation module.

Each floatation module may have a three-dimensional geometric shape. A floatation module may have a generally spherical shape (see FIG. 3A). A floatation module may have a generally cylindrical shape (see FIG. 3B). A floatation module may have a generally conical shape (see FIG. 3C). A floatation module may have a generally hexagonal prism shape (see FIG. 3D). A floatation module may have a generally toroidal shape (see FIG. 3E). A floatation module may have a generally ellipsoidal shape (see FIG. 3F). It is noted that in some embodiments, as shown in FIG. 3C, the base of the conical shape may be the closest point (e.g., first point (216)) to the first surface; however, such is not required, and in some embodiments, the conical shape could be inverted such that the base is furthest from the first surface. A floatation module may have an annular shape (see FIG. 3D).

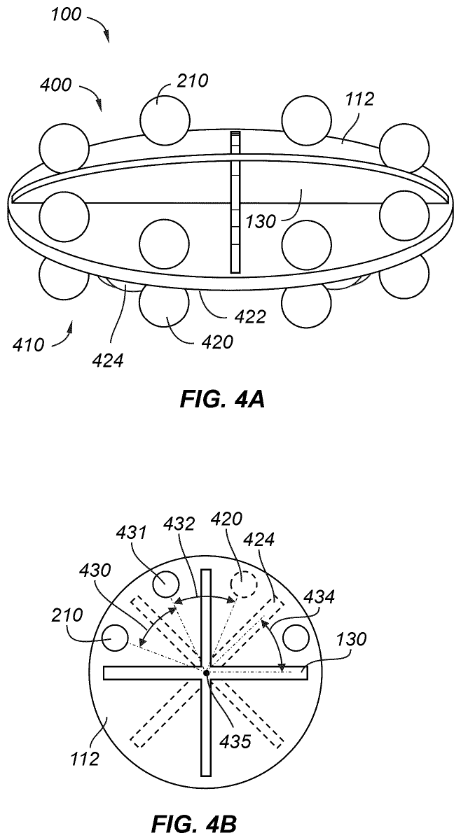

Referring to FIG. 4A, a reversible device is shown. The device may include a first side (400) and a second side (410). The first side may include one or more floatation modules (210) disposed upon a first surface (112) which may be a substantially flat surface. The first side may include one or more features (130) (such as protrusions) disposed upon the first surface. The second side may include one or more floatation modules (420). The number of floatation modules on the first side may be the same as the number of floatation modules on the second side. The number of floatation modules on the first side may be greater than the number of floatation modules on the second side. The number of floatation modules on the first side may be less than the number of floatation modules on the second side. The floatation modules on the first side may be the same as the number of floatation modules on the second side.

Referring to FIG. 4B, an angle (430) may be formed at the central axis (435) or centroid of the device, between two lines extending from the central axis to the center of two adjacent floatation modules on the same side of the device (e.g., floatation module (210) and floatation module (431)). The angle (430) will be formed in a plane parallel to the first surface (112), such that the central axis is normal to the plane. In some embodiments, the angle (430) between every pair of adjacent floatation modules is the same. In some embodiments, the angle (430) between at least one pair of adjacent floatation modules is the different from the angle between a different pair. In some embodiments, angle (430) may be less than 180 degrees. In some embodiments, angle (430) may be no more than 90 degrees. In some embodiments, angle (430) may be less than 90 degrees. In some embodiments, angle (430) may be less than 60 degrees. In some embodiments, angle (430) may be no more than 45 degrees. In some embodiments, angle (430) may be at least 30 degrees. In some embodiments, angle (430) may be at least 45 degrees. In some embodiments, angle (430) may be at least 60 degrees. In some embodiments, angle (430) may be at least 90 degrees. In some embodiments, angle (430) may be at least 120 degrees.

In some embodiments, an angle (432) may be formed at the central axis (435) or centroid of the device, between two lines extending from the central axis to the center of two closest floatation modules on opposite sides of a device (e.g., a floatation module (431) on the first side and a floatation module (420) on the second side). The angle (432) will be formed in a plane parallel to the first surface (112), such that the central axis is normal to the plane. In some embodiments, the angle (432) may be 0 degrees (e.g., the center of a floatation module (431) on a first side may be axially aligned with a center of a floatation module (420) on the second side. This can be seen in FIG. 4A. In some embodiments, the angle (432) between every closest pair of floatation modules on opposite sides is the same. In some embodiments, the angle (432) between at least one pair of closest floatation modules is the different from the angle between a different pair. In some embodiments, angle (432) may be less than 180 degrees. In some embodiments, angle (432) may be no more than 90 degrees. In some embodiments, angle (432) may be less than 90 degrees. In some embodiments, angle (432) may be less than 60 degrees. In some embodiments, angle (432) may be no more than 45 degrees. In some embodiments, angle (432) may be no more than 30 degrees. In some embodiments, angle (432) may be greater than 0 degrees. In some embodiments, angle (432) may be at least 15 degrees. In some embodiments, angle (432) may be at least 30 degrees. In some embodiments, angle (432) may be at least 45 degrees. In some embodiments, angle (432) may be at least 60 degrees. In some embodiments, angle (432) may be at least 90 degrees. In some embodiments, angle (432) may be at least 120 degrees.

In some embodiments, an angle (434) may be formed at the central axis (435) or centroid of the device, between two lines extending from the central axis to the center of two closest protrusions on opposite sides of a device (e.g., one or more features (130), such as protrusions, on the first side and a protrusion (424) on the second side). The angle (434) will be formed in a plane parallel to the first surface (112), such that the central axis is normal to the plane. In some embodiments, the angle (434) may be 0 degrees (e.g., the protrusions on one side mirror the protrusions on the reverse side). In some embodiments, the angle (434) between every closest pair of protrusions on opposite sides is the same. In some embodiments, the angle (434) between at least one pair of closest protrusions is the different from the angle between a different pair. In some embodiments, angle (434) may be less than 180 degrees. In some embodiments, angle (434) may be no more than 90 degrees. In some embodiments, angle (434) may be less than 90 degrees. In some embodiments, angle (434) may be less than 60 degrees. In some embodiments, angle (434) may be no more than 45 degrees. In some embodiments, angle (434) may be no more than 30 degrees. In some embodiments, angle (434) may be greater than 0 degrees. In some embodiments, angle (434) may be at least 15 degrees. In some embodiments, angle (434) may be at least 30 degrees. In some embodiments, angle (434) may be at least 45 degrees. In some embodiments, angle (434) may be at least 60 degrees. In some embodiments, angle (434) may be at least 90 degrees. In some embodiments, angle (434) may be at least 120 degrees.

In some embodiments, angle (432) between closest floatation modules on opposite sides may be smaller than angle (434) between closest protrusions on opposite sides. This can be seen in FIG. 4A, where the angle (432) between closest floatation modules would be zero degrees, while angle (434) between closest protrusions on opposite sides would be 45 degrees. In some embodiments, angle (432) between closest floatation modules on opposite sides may be larger than angle (434) between closest protrusions on opposite sides. In some embodiments, angle (432) between closest floatation modules on opposite sides may be the same as angle (434) between closest protrusions on opposite sides.

There could be one or more weights to control the position of the evaporation units—the weight materials can be solid or liquid materials that have density higher than the brine, and they can be contained under the device or anchored onto the device.

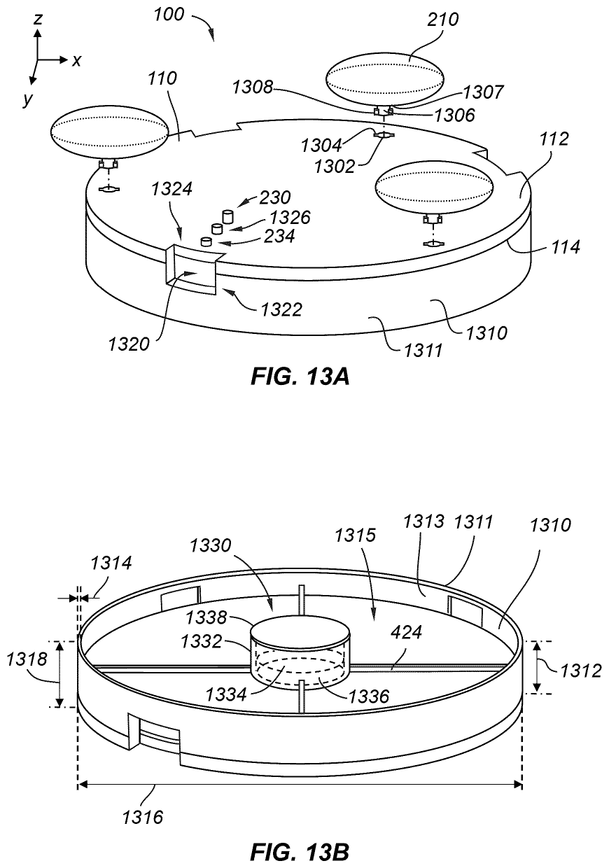

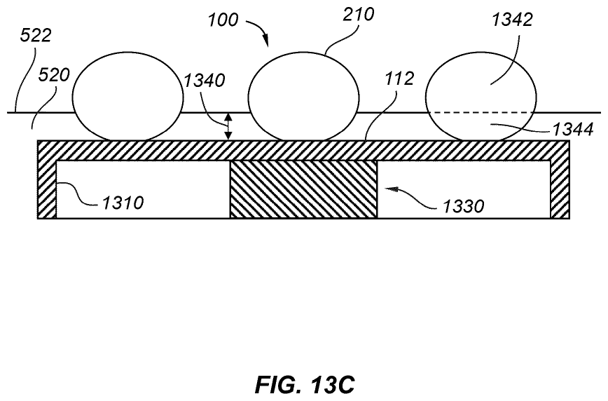

Referring to FIGS. 13A and 13B, another embodiment may be seen. A device (100) is shown having a central portion (110) with a first surface (112), which may be a substantially flat surface. A sidewall (1310) may extend downward (e.g., in the-z direction) from a second surface (114). As shown, the first surface may generally face in the z-direction, while the second surface may generally face in the −z direction. The sidewalls (1310) may have a height (1312) and a thickness (1314). The height of the sidewall may be at least 50%, at least 60%, at least 70%, at least 80%, or at least 90% of a total height (1318) of sidewalls plus the central portion. The thickness of the sidewalls may be less than 5%, less than 4%, less than 3%, less than 2%, or less than 1% of a total diameter (1316) or width of the device.

As shown, the floatation modules (210) may be removably coupled from embodiments of the device. Various techniques to accomplish this are well known. For example, the central portion (110) may include a hole (1302) with additional cutouts (1304). The floatation module may include a stem portion (1106) extending away from a bottom surface (1307) of the floatation module (210). The step may include one or more tabs or protrusions (1308) configured to be inserted through the additional cutouts. After insertion, the floatation modules can be twisted (e.g., 90 degrees) such that the tabs or protrusions no longer align with the additional cutouts, and the bottom surface (1307) of the floatation module is pressed against the first surface (112).

The first surface may include multiple protrusions, including first protrusion (230), second protrusion (234), and a third protrusion (1326).

The device may include one or more openings (1320) extending from an external surface (e.g., external surface (1311) of the sidewalls) to an internal surface (e.g., internal surface (1313) of the sidewalls). This may allow a fluid to flow through the opening and into (or out of) an internal volume of space (1315) below the central portion of the device, the volume of space being defined by the sidewalls. The openings may include a portion (1322) that extends through the sidewalls. The openings may include a portion (1324) that extends through the central portion (110) of the device (e.g., from a first surface to the second surface). In some embodiments, there are a plurality of openings. In some embodiments, there are an even number of openings. In some embodiments, there are an odd number of openings. In some embodiments, a ratio of openings to floatation modules is 1:1 to 1:2.

There may be a container (1330) coupled to the bottom of the device, at least partially within the internal volume of space (1315), and preferably entirely within the internal volume of space. The container may include walls (1332) defining an internal volume (1334) of the container. The internal volume of the container may contain a material (1336). This material (1336) may be a material used to add additional buoyancy (e.g., if the material is less dense than the fluid in which the device is to be used). This material (1336) may be used as a weight (e.g., if the material is denser than the fluid in which the device is to be used). The material may include a gas. The material may include a liquid or solid. The material may include, e.g., sand, a metal, etc. The container may include a lid (1338). The lid may be permanently affixed. The lid may be removably coupled to the container.

Referring to FIG. 13C, a device (100) like that of FIG. 13A can be seen disposed such that the first surface (112) is a distance (1340) below a surface (522) of a fluid (520).

As shown, a majority of the floatation modules (210) may be above the surface (522) of the fluid. In some embodiments, the volume (1342) of the floatation modules (“volume above”) that lies above the surface of the fluid is more than the volume (1344) of the flotation modules that lie below the surface. In some embodiments, the volume above is at least 60% of the total volume of the floatation modules. In some embodiments, the volume above is at least 70% of the total volume of the floatation modules. In some embodiments, the volume above is no more than 90% of the total volume of the floatation modules. In some embodiments, the volume above is no more than 80% of the total volume of the floatation modules.

The distance (1340) that the central portion lies below the fluid surface may be controlled in various ways. The density of the device materials of construction may be increased (to increase distance (1340)) or decreased (to decrease distance (1340). Floatation modules may be removed (to increase distance (1340)) or added (to decrease distance (1340). Weights (such as weights in container (1330) may be added (to increase distance (1340)) or removed (to decrease distance (1340).

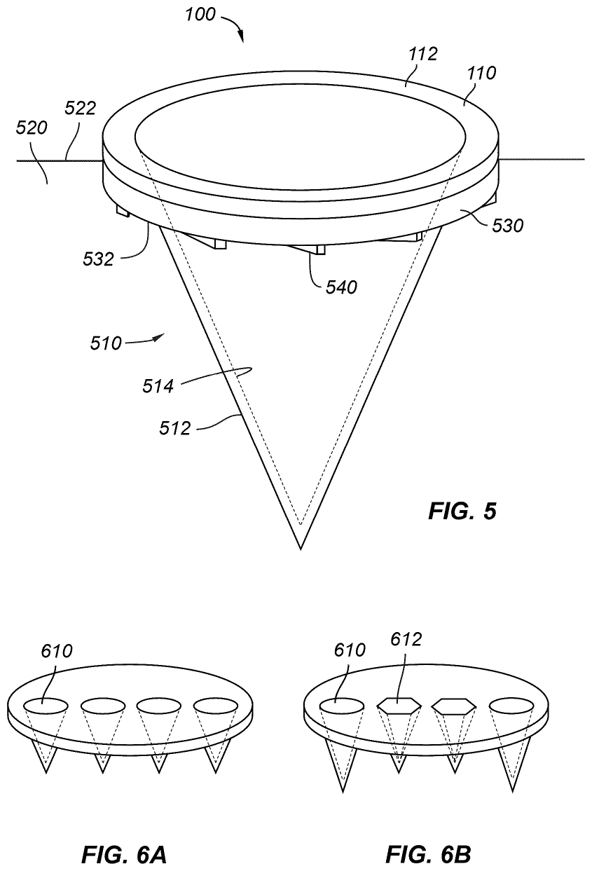

Referring to FIG. 5, the solar absorption material may define at least one hollow, three-dimensional shape (510). The at least one hollow, three-dimensional shape may be configured to extend down into a fluid (520) (e.g., blow the surface (522) of the fluid) from a base substrate (530) when the device is placed in the liquid. Note, the base substrate may be a base substrate as disclosed herein with regards to the plurality of layers (168). In some aspects, at least one hollow, three-dimensional shape may include the base substrate. However, in some aspects, the at least one hollow, three-dimensional shape may not include any base substrate layer.

The base substrate (530) may be configured to float on a surface (522) of a fluid (520). The base substrate may be partially submerged. The solar absorption material may have a first surface (512) configured to be in contact with a surface of the liquid and a second opposing surface (514) configured to be in contact with air.

The solar absorption material may contain at least one hydrophobic surface (e.g., first surface (512), second surface (514), or a combination thereof.

The device of claim 24, wherein further comprising a superhydrophobic spray coating on at least one surface of the solar absorption material.

The device may include one or more protrusions (540) configured to extending downwards from the base substrate (530) (e.g., away from bottom surface (532) of the base substrate). The protrusion(s) may be configured to be disposed within a fluid (520) (e.g., below the surface (522) of the liquid) when the device is placed in a liquid. The one or more protrusions may be configured to cause the device to rotate when disposed in the liquid.

Referring to FIG. 6A, the at least one hollow, three-dimensional shape may include a plurality of hollow, three-dimensional shapes. Each hollow, three-dimensional shape may be identical. In FIG. 6A, four identical circular conic shapes (610) are shown. However, in some aspects, at least one hollow, three-dimensional shape may be different from at least one other hollow, three-dimensional shape. In FIG. 6B, the device is shown as including two longer identical circular conic shapes (610) and two identical hexagonal conic shapes (612) that are shorter (and shaped differently) from the circular conic shapes (610).

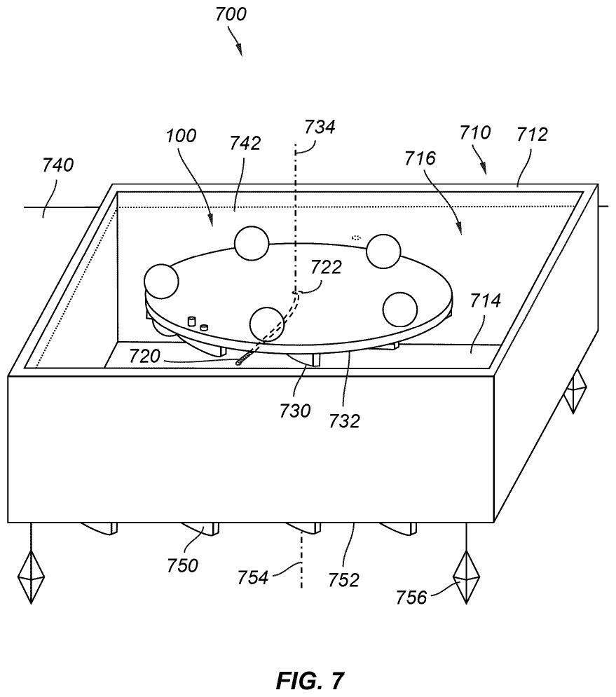

In various aspects, a floating evaporator may be provided. Referring to FIG. 7, the floating evaporator (700) may include a porous frame (710). The porous frame may have sidewalls (712) and a bottom surface (714) that define an internal volume of space (716). The sidewalls may be sufficiently porous so as to allow a fluid (740) to pass through the sidewalls. The sidewalls may be non-porous. The bottom surface may be sufficiently porous so as to allow a fluid to pass through the bottom surface. The bottom surface may be non-porous. In some embodiments, the pores may include microscopic pores. In some embodiments, the pores may include macroscopic pores.

The porous frame may be comprised of a polymeric material. The polymeric material may be polylactic acid (PLA), acrylonitrile butadiene styrene (ABS), acrylonitrile styrene acrylate (ASA), High-Density Polyethylene (HDPE), polyethylene terephthalate (PET), polypropylene (PP), polyether ether ketone (PEEK), or a combination thereof.

The porous frame may be configured to allow a fluid (740) (e.g., a liquid, such as water) to enter the internal volume of space (e.g., external fluid may pass through the porous frame 710, such that the internal volume of space contains fluid (742).

The evaporator may include an embodiment of a device (100) as disclosed herein. The evaporator may include multiple devices. The evaporator may include a single device. The device may be disposed at least partially within the internal volume of space. The device may be disposed completely within the internal volume of space. In some embodiments, the device may be directly or indirectly coupled to the porous frame. In some embodiments, a tether (720) may be configured to couple the device to porous frame (in FIG. 7, tether (720) is shown as being connected to bottom surface (714) and a central portion (722) on the bottom surface (732) of the device (100).

The evaporator may include at least one surface feature configured to cause the floating evaporator to rotate around an axis based on evaporation rate of the fluid. In some embodiments, porous frame (710) may include at least one surface feature (750), such as a protrusion (shown here extending away from the bottom (752) of the bottom surface (714) of the evaporator, although such features could be readily coupled to any appropriate surface), These features may be configured to cause the porous frame to rotate around an axis (754) based on evaporation rate of the fluid. In some embodiments, the device (100) may include at least one surface feature (730), such as a protrusion, configured to cause the device to rotate around an axis (734) based on evaporation rate of the fluid.

The floating evaporator may include a weight or buoyant material operably coupled to the bottom surface of the porous frame. For example, in embodiments, one or more weights (756) or buoyant materials may be coupled to the bottom surface (714) of the porous frame.

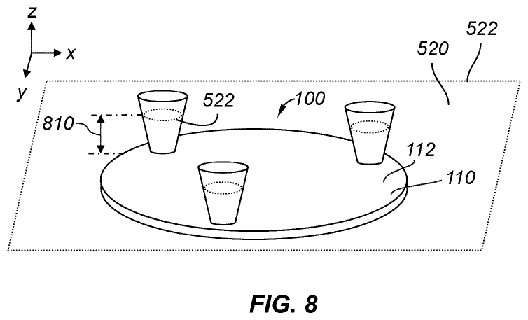

In various aspects, a system may be provided. Referring to FIG. 8, the system may include a fluid (520). The fluid may be a liquid. The liquid may include water. The liquid may be non-potable water (e.g., water that is not suitable for drinking including, for example, brine water; saltwater; ground water; waste water; contaminated water, chemically, microbial, or otherwise; or raw water). The liquid may be wastewater (e.g., residential, commercial, and/or industrial wastewater). The liquid may be seawater or saltwater. The liquid may be brine water. The liquid may include a target mineral (such as lithium) to be removed.

The system may include one or more devices, each device (100) being an embodiment of a device as disclosed herein. The device(s) may each be disposed within the liquid. A first surface (112) (which is preferably a substantially flat surface) of the solar absorption material faces may face upwards (e.g., in the z-direction). The substantially flat surface of each device may be disposed an average distance (810) (d) below a surface (522) of the fluid (in FIG. 8, the surface is shown as being in the xy-plane) when the device is placed in the fluid, where 0<d≤10 cm.

In some embodiments, d is no more than 10 cm. In some embodiments, d is no more than 9 cm. In some embodiments, d is no more than 8 cm. In some embodiments, d is no more than 7 cm. In some embodiments, d is no more than 6 cm. In some embodiments, d is no more than 5 cm. In some embodiments, d is no more than 4 cm. In some embodiments, d is no more than 3 cm. In some embodiments, d is no more than 2 cm. In some embodiments, d is no more than 1 cm. In some embodiments, d is no more than 5 mm. In some embodiments, d is at least 1 mm. In some embodiments, d is at least 2 mm. In some embodiments, d is at least 3 mm.

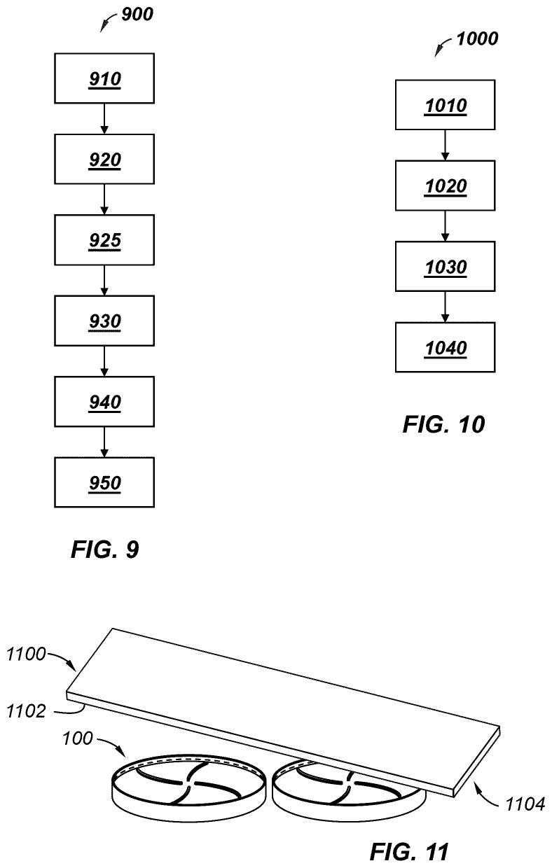

In various aspects, a method for enhancing solar evaporation may be disclosed. Referring to FIG. 9, the method (900) may include providing (910) an embodiment of a device as disclosed herein. The method may include allowing (920) a fluid (such as a liquid) to contact the device. In some embodiments, this may include allowing the fluid to contact an embodiment of a solar absorption material as disclosed herein. This may include allowing the fluid to flow over a surface of the solar absorption material.

The method may include positioning (925) the device at least partially below a surface of the fluid, such that the device is configured to trap solar energy in a volume of space from the surface to an average distance d below the surface, where 0<d≤10 cm (see, e.g., FIG. 8).

The method may include at least partially exposing (930) the device (and specifically the solar absorption material) to a solar energy source (e.g., exposure to natural solar energy or to an energy source mimicking solar irradiation). The method may include allowing (940) at least some of the liquid to be evaporated during the time when the device is at least partially exposed to solar energy.

After allowing at least some of the liquid to be evaporated, the method may include removing (950) at least one target material from an external surface of the device. This may be done manually or automatically. This may be done mechanically (e.g., sweeping or vibrating the surface, etc.).

The at least one target material may be is a metal. The at least one target material may be an alkali metal. The at least one target material may be an alkaline earth metal. The at least one target material may be a transition metal. The at least one target material may be is lithium.

In certain aspects, a method for collecting a target material from a fluid may be provided. The fluid may comprise water. The fluid may comprise at least two metals. The two metals may include at least one alkali metal. The two metals may include two alkali metals. The two metals may include at least one alkaline earth metal. The two metals may include at least one transition metal.

Referring to FIG. 10, the method (1000) may include providing (1010) an embodiment of a device as disclosed herein. The device may include a selective mineral adsorption layer that is selective to the target material. The method may include allowing (1020) the fluid to contact the device.

The method may include evaporating (1030) at least one material from the fluid. The method may include collecting (1040) either the at least one material or that was evaporated, or a material remaining on a surface of the device. Referring to FIG. 11, a simple example of this may be shown, where one or more devices may be disposed beneath an optical and/or IR-transparent membrane (1100), which may be angled such that when fluid evaporates from a device (100), it contacts a bottom surface (1102) of the membrane, condenses on the bottom surface, and then runs to a bottom edge (1104) of the membrane, where it can be collected (e.g., by a container).

Various modifications may be made to the systems, methods, apparatus, mechanisms, techniques, and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

1. A device for enhancing solar evaporation, comprising:
a solar absorption material comprising a carbonaceous light absorbing layer, the solar absorption material forming a substantially flat surface;
wherein a buoyancy of the device is configured or configurable such that the solar absorption material will be disposed an average distance d below a surface of a liquid when the device is placed in the liquid, where 0<d≤10 cm.

2. The device of claim 1, wherein the solar absorption material consists of a plurality of layers, the plurality of layers including:
the carbonaceous light absorbing layer; and
at least one additional layer, the at least one additional layer consisting of:
a reflective layer disposed below the carbonaceous light absorbing layer;
an anti-reflection layer disposed above the carbonaceous light absorbing layer; and/or
a first layer disposed above the carbonaceous light absorbing layer and any anti-reflection layer, the first layer consisting of an anti-scaling layer, a photocatalyst layer, or a selective mineral adsorption layer.

3. The device of claim 2, wherein the reflective layer comprises aluminum and an acrylic polymer.

4. The device of claim 2, wherein the carbonaceous light absorbing layer comprises carbon black particles.

5. The device of claim 4, wherein the carbon black particles are disposed in the carbonaceous light absorbing layer in a size gradient.

6. The device of claim 4, wherein the carbonaceous light absorbing layer further comprises silicone dioxide nanoparticles disposed over the carbon black particles.

7. The device of claim 2, wherein the photocatalyst layer includes a photocatalyst in a binder resin.

8-11. (canceled)

12. The device of claim 1, wherein the anti-scaling layer comprises an organosilane and/or at least one layer of polyacrylic acid (PAA) coupled to at least one layer of polyethylenimine.

13. The device of claim 1, wherein the solar absorption material contains at least one hydrophobic surface.

14-16. (canceled)

17. The device of claim 1, wherein the solar absorption material has a curved surface facing upwards.

18. The device of claim 1, wherein the solar absorption material has a substantially planar surface facing upwards.

19. (canceled)

20. The device of claim 1, wherein the average distance d is configured to be adjusted by adding or removing a floatation module, adding or removing a weight, or selecting a material of construction with a different density.

21. The device of claim 1, wherein a buoyancy of the device is configured or configurable such that the substantially flat surface will be disposed an average distance d2 below a surface of a liquid when the device is placed in the liquid, where 0.1 mm≤d2≤10 mm.

22. (canceled)

23. The device of claim 1, wherein the device is configured to be placed in a fluid, such that a layer of the fluid disposed above the device will be evaporated at a rate greater than a rate due to bulk evaporation.

24. The device of claim 1, further comprising one or more floatation modules operably coupled to the substantially flat surface, the one or more floatation modules configured to control buoyancy of the device.

25-36. (canceled)

37. The device of claim 1, further comprising a base substrate coupled to the solar absorption material.

38-46. (canceled)

47. A floating evaporator, comprising:
a porous frame with sidewalls and a bottom surface defining an internal volume of space, the porous frame allowing a fluid to enter the internal volume of space; and
a device of claim 1, coupled to the porous frame and disposed in the internal volume of space.

48-51. (canceled)

52. A method for enhancing solar evaporation, comprising:
providing a device of claim 1, and allowing a liquid to contact the device; and
allowing at least some of the liquid to be evaporated when the device is at least partially exposed to solar energy.

53-55. (canceled)

56. A method for collecting a target material from a fluid, comprising:
providing a device of claim 1, the device including a selective mineral adsorption layer that is selective to the target material;
allowing the fluid to contact the device; and
evaporating at least one material from the fluid and collecting either the at least one material or a material remaining on a surface of the device.

57-58. (canceled)

59. A system for evaporating a liquid, comprising:
a liquid; and
one or more devices of claim 1, each disposed within the liquid, where the substantially flat surface of each device is disposed an average distance d below a surface of a liquid when the device is placed in the liquid, where 0<d≤10 cm.

60-68. (canceled)
